(19) United States
(12) Patent Application Publication
(10) Pub. No.: US 2026/0271954 A1
(43) Pub. Date: Sep. 17, 2026

(54) NON-HYDROGENATED VEGETABLE FAT COMPOSITION

(71) Applicant: Cargill, Incorporated, Wayzata, MN (US)

(72) Inventors: Guifang CHANG, Shanghai (CN); Saiyan DING, Nantong (CN); Yun GE, Nantong (CN); Haiyong SHEN, Nantong (CN); Yaobin SI, Shanghai (CN)

(73) Assignee: Cargill, Incorporated, Wayzata, MN (US)

(21) Appl. No.: 19/472,213

(22) PCT Filed: Apr. 7, 2023
(86) PCT No.: PCT/CN2023/086842

§ 371 Date: Oct. 3, 2025

(51) Int. Cl. A23D 7/005; A23D 7/00; A23D 9/007

(52) U.S. Cl. CPC A23D 7/0056; A23D 7/001; A23D 9/007

(57) ABSTRACT

A non-hydrogenated fat composition comprising a liquid oil and a hardstock fat and the preparation process thereof. The liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition. Also disclosed is a food product comprising a food ingredient different from a fat, and a non-hydrogenated vegetable fat composition, and a use of a non-hydrogenated vegetable fat composition to reduce oil leakage from a food product.

### FILED OF THE INVENTION

The present invention relates to a non-hydrogenated vegetable fat composition comprising a liquid oil and a hardstock fat. The invention further relates to a food product comprising the non-hydrogenated vegetable fat composition.

### BACKGROUND

Fats used in food product applications preferably have good plasticity and heat stability. Special applications, such as margarine and spreads, require additional features like a wide range of operating temperature and fine crystallization. However, for margarines having good plasticity and heat stability, they usually have high slipping melting points (SMP) and saturated fatty acids. Margarine and spreads are water-in-oil (W/O) emulsions, which have an aqueous phase dispersed as fine droplets in liquid oil stabilized within a network of solid fat crystals. The lipid phase in margarine is typically a mixture of fats and oils. Fats that are solid at room temperature contain a high percentage of saturated fatty acids, while liquid oils have a high percentage of unsaturated fatty acids. In margarine technology, the composition of the lipid phase is carefully chosen to have a desired ratio of liquid oil and solid fat to obtain a product with desired plasticity and spreadable consistency, as well as good in-mouth melting properties.

Liquid vegetable oils are preferred over solid fat and animal fat because their unsaturated fatty acids enhance the overall nutritional value. However, margarine is easy to exudate when containing a high quantity of liquid oils.

Hydrogenation is usually involved in the preparation of fat-containing food products such as margarine; however, hydrogenation leads to formation of trans fatty acids and saturated fatty acids. As advised by renowned health organizations such as the World Health Organization (WHO), intake of saturated fats should be limited as they have been proved to link with cardiovascular diseases. Therefore, hydrogenation has increasingly been considered as an unwanted process that gives unhealthy products and consumer preference is merging clearly to food products that are substantially free of hydrogenated fats.

EP0151450 discloses a fat blend having a relatively low level of trans fatty acids and the fat blend is obtained by random interesterification of lauric fats, saturated fats, and partially hydrogenated fats. Hydrogenation is used in preparing the fat blend and artificial trans fatty acids are also present in the fat blend.

EP1917336 discloses a non-hydrogenated hard stock fat which is obtained by interesterification of palm oil, lauric oil, shea olein, and liquid oil.

WO2006/131539 discloses a non-hydrogenated vegetable fat composition having an interesterified fat obtained by subjecting a blend of lauric fat and non-lauric fat to an interesterification.

Thus, there is a need in the food industry to develop vegetable based food products having fat compositions without any hydrogenated components that provide improved plasticity and heat stability to the food products.

### SUMMARY

The present disclosure provides a non-hydrogenated fat composition comprising a liquid oil and a hardstock fat. The liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition.

The present disclosure also provides a method for preparing a non-hydrogenated vegetable fat composition that comprises the step of blending a liquid oil and a hardstock fat.

The present disclosure also provides a food product comprising a food ingredient different from a fat, and a non-hydrogenated vegetable fat composition.

The present disclosure further provides a use of a non-hydrogenated vegetable fat composition to reduce oil leakage from a food product. The food product is selected from the group consisting of margarine, shortening, non-dairy topping, non-dairy cream, filling, and spread.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless otherwise indicated, the phrase “suitable for human consumption” means that the composition is generally recognized as safe for eating and drinking and as not being toxic, poisonous, or otherwise harmful to humans when used in functionally useful amounts in solid and liquid food products.

Unless expressly stated, ppm (parts per million), percentage, and ratios are on a by weight basis. Percentage on a by weight basis is also referred to as wt. % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, “room temperature” or “RT” refers to a temperature between 20° C. to 25° C.

### Non-Hydrogenated Vegetable Fat Composition

The present invention relates to a non-hydrogenated vegetable fat composition comprising a liquid oil and a hardstock fat.

The liquid oil is present in the fat composition an amount of 25 to 75 wt. %, 25 to 70 wt. %, or 35 to 45 wt. %, 25 to 70 wt. %, or 35 to 45 wt. % based upon total weight of the fat composition.

The hardstock fat is present in the fat composition an amount of 25 to 75 wt. %, 30 to 75 wt. %, or 55 to 65 wt. %, based upon total weight of the fat composition.

The fat composition may also have a triglyceride composition having, based on total weight of the triglycerides, a combined content of C44 to C48 triglycerides in an amount of from 10 to 25 wt. %.

The fat composition may have a triglyceride composition having, based on total weight of the triglycerides, a content of C54 triglycerides in an amount of from 30 to 50 wt. %.

The fat composition may have a fatty acid profile having, based on total weight of the fatty acids, a combined content of C12 and C16 fatty acids in an amount of from 25 to 34 wt. %. Preferably, the fat composition may have a fatty acid profile having a ratio of C12 fatty acids to C16 fatty acids from 0.19 to 0.24.

The fat composition may have a fatty acid profile having, based on total weight of the fatty acids, a content of C18:0 fatty acids in an amount of from 4.2 to 4.4 wt. %, a content of C18:1 fatty acids in an amount of from 24.2 to 25.9 wt. %, a content of C18:2 fatty acids in an amount of from 29.6 to 36.9 wt. %, and a content of C18:3 fatty acids in an amount of from 3.5 to 4.1 wt. %.

The fat composition may have a fatty acid profile having, based on total weight of the fatty acids, unsaturated fatty acids in an amount of from 55 to 75 wt. %.

The fat composition comprises no hydrogenated fats.

The fat composition may have a solid fat content (SFC) that is at least 38 wt. % at 10° C. and less than 3 wt. % at 40° C. Solid fat content is measured according to standard methods AOCS Cd 16b-39 or IUPAC 2.150a.

### Hardstock Fat

Hardstock fat is an interesterified fat obtained by subjecting to an interesterification a blend of an amount of 25 to 45 wt. %, or 35 to 40 wt. %, of at least one lauric fat, and an amount of 55 to 75 wt. %, or 60 to 65 wt. %, of at least one non-lauric fat based on the weight of the hardstock fat. The interesterification process can be chemical or enzymatic.

Examples of lauric fat may include, but not be limited to, palm kernel oil, palm kernel stearin, palm kernel olein, coconut oil, coconut stearin, coconut olein, or a blend of two or more thereof. Palm kernel stearin and palm kernel olein may be fractionated from palm kernel oil. Coconut stearin and coconut olein may be fractionated from coconut oil.

Examples of non-lauric fat may include, but not be limited to, palm oil, soybean oil, rapeseed oil, maize oil, sunflower oil, flaxseed oil, or a blend of two or more thereof.

The hardstock fat may have a triglyceride composition having, based on total weight of the triglycerides, a combined content of C44 to C48 triglycerides in an amount of from 45 to 50 wt. %.

The hardstock fat may have a fatty acid profile, based on total weight of the fatty acids, a combined content of C12 and C16 fatty acids in an amount of from 55 to 60 wt. %. Preferably, the combined content of C12 and C16 fatty acids in the fatty acid profile of the hardstock fat is 58.4 wt. % based on total weight of the fatty acids.

The hardstock fat may have a fatty acid profile having a ratio of C12 fatty acids to C16 fatty acids from 0.3 to 0.5. Preferably, the ratio of C12 fatty acids to C16 fatty acids in the fatty acid profile of the hardstock fat is 0.4.

The hardstock fat may have a fatty acid profile having, based on total weight of the fatty acids, a content of C18:0 fatty acids in an amount of from 4.0 to 4.2 wt. %, a content of C18:1 fatty acids in an amount of from 22.8 to 23.0 wt. %, a content of C18:2 fatty acids in an amount of from 4.4 to 4.6 wt. %, and a content of C18:3 fatty acids in an amount of from 0.1 to 0.2 wt. %. Preferably, the hardstock fat may have a fatty acid profile having, based on total weight of the fatty acids, a content of C18:0 fatty acids in an amount of 4.1 wt. %, a content of C18:1 fatty acids in an amount of 22.9 wt. %, a content of C18:2 fatty acids in an amount of 4.5 wt. %, and a content of C18:3 fatty acids in an amount of 0.1 wt. %.

In a preferred aspect of the present invention, the hardstock fat is an interesterified fat obtained by subjecting to a chemical or enzymatic interesterification a blend of an amount of 25 to 45 wt. %, or 35 to 40 wt. %, of at least one lauric fat, and an amount of 55 to 75 wt. %, or 60 to 65 wt. %, of at least one non-lauric fat based on the weight of the hardstock fat. Preferably chemical interesterification is applied. The triglyceride composition of the hardstock fat has, based on total weight of the triglycerides: a combined content of C44 to C48 triglycerides in an amount of from 45 to 50 wt. %; and a combined content of C12 and C16 fatty acids in an amount of from 55 to 60 wt. %. The fatty acid profile of the fat composition has a ratio of C12 to C16 fatty acids from 0.3 to 0.5 and, based on total weight of the fatty acids: a combined content of C12 and C16 fatty acids in an amount of from 55 to 60 wt. %; and a content of C18:0 fatty acids in an amount of from 4.0 to 4.2 wt. %, a content of C18:1 fatty acids in an amount of from 22.8 to 23.0 wt. %, a content of C18:2 fatty acids in an amount of from 4.4 to 4.6 wt. %, and a content of C18:3 fatty acids in an amount of from 0.1 to 0.2 wt. %

### Liquid Oil

Liquid oil in the fat composition is a vegetable oil. Preferably, the liquid oil is non-hydrogenated. Examples of liquid oil may include, but not be limited to, soybean oil, sunflower oil, rapeseed oil, high oleic sunflower oil, high oleic rapeseed oil, corn oil, flaxseed oil, or blends of two or more thereof.

Preferably, the liquid oil has a fatty acid profile having more than 80 wt. % unsaturated fatty acids, based on total weight of the liquid oil.

### Food Product

The present invention also relates to a food product comprising a food ingredient different from a fat, and the non-hydrogenated vegetable fat composition. Examples of the food product may include, but not be limited to, margarine, shortening, non-dairy topping, non-dairy cream, filling, or spread.

Examples of the food ingredient different from a fat may include, but not be limited to, water, salt, sweetening agents, coloring agents, flavoring agents, preservatives, anti-oxidants, acidity regulator, or combinations thereof.

Preferably, the food product is a margarine. The margarine may have a slipping melting point (SMP) of less than or equal to 36° C. SMP is measured according to standard methods ISO 6321:2021.

The margarine may have, based on the total weight of the margarine, the non-hydrogenated vegetable fat composition in an amount of from 70 to 90 wt. %, or from 80 to 85 wt. %, and an aqueous solution in an amount of 10 to 30 wt. %.

The aqueous solution may include, but not be limited to, water, cow's milk, sheep's milk, goat's milk, soybeans milk, coconut water, almond milk, apple juices, syrup or combinations of two or more thereof. Preferably, the aqueous solution is water.

The present invention relates to the food product, wherein the margarine has a plasticity of at least 50 g/cm².

The present invention relates to the food product, wherein the margarine has a slipping melting point (SMP) of less than or equal to 36° C.

### Use of Non-Hydrogenated Vegetable Fat Composition

The present invention also relates to a use of the non-hydrogenated vegetable fat composition to reduce oil leakage. Examples of the food product may include, but not be limited to, margarine, shortening, non-dairy topping, non-dairy cream, filling, or spread.

Preferably, there is no oil leakage at 30° C. and for at least 5 hours.

The food product may have a fatty acid profile having, based on total weight of the fatty acids, unsaturated fatty acids in an amount of from 55 to 75 wt. %.

The food product may have a fatty acid profile having, based on total weight of the fatty acids, poly-unsaturated fatty acids in an amount of from 30 to 55 wt. %.

### Process of Preparation of Non-Hydrogenated Vegetable Fat Composition

The non-hydrogenated vegetable fat composition of the present invention can be prepared by blending a liquid oil and a hardstock fat. The liquid oil is present in an amount of 25 to 75 wt. %, 25 to 70 wt. %, or 35 to 45 wt. %, based upon total weight of the fat composition. The hardstock fat is present in an amount of 25 to 75 wt. %, 30 to 75 wt. %, or 55 to 65 wt. %, based upon total weight of the fat composition.

The fat composition can then be used to prepare a food product, preferably a margarine, by any conventional method for making margarines or other water-in-oil spreads known to a person skilled in the art.

### Advantages of the Invention

As described above, the non-hydrogenated vegetable fat composition of the present invention is a healthy formula with a high percentage of unsaturated fatty acids. The contents of saturated fatty acids and trans fatty acids are low in the non-hydrogenated vegetable fat composition.

It has surprisingly been found that the non-hydrogenated vegetable fat composition of the present invention has a good plasticity and good heat stability with desired plastic and spreadable consistency, as well as good in-mouth melting properties. The non-hydrogenated vegetable fat composition of the present invention has also been found to resist heat at high temperature and be not hard at low temperature.

### CLAUSES

1. A non-hydrogenated vegetable fat composition comprising:
   a. a liquid oil; and
   b. a hardstock fat;
   wherein the liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition, and wherein the fat composition comprises a triglyceride composition comprising, based on total weight of the triglycerides, a content of C54 triglycerides in an amount of from 30 to 50 wt. %.
2. The non-hydrogenated vegetable fat composition according to clause 1, wherein the fat composition comprises a triglyceride composition comprising, based on total weight of the triglycerides, a combined content of C44 to C48 triglycerides in an amount of from 10 to 25 wt. %.
3. A food product comprising a food ingredient different from a fat, and the fat composition according to any one of clause 1 to 2.
4. The food product according to clause 3 wherein the food product is selected from margarine, shortening, non-dairy topping, non-dairy cream, filling and spread.
5. The food product according to clause 3 or 4 wherein the food product is a margarine comprising from 70 wt. % to 90 wt % of the fat composition according to any one of clause 1 to 2.
6. The food product according to clause 5 wherein the margarine is comprising 10 wt % to 30 wt % water.
7. The food product according to any one of clause 3 to 6 wherein the food product is comprising the non-hydrogenated vegetable fat composition and the fat composition is comprising:
   a. a liquid oil; and
   b. a hardstock fat; and
   the liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition, and
   the fat composition comprises a triglyceride composition comprising, based on total weight of the triglycerides, a content of C54 triglycerides in an amount of from 30 to 50 wt. %.
8. The food product according to any one of clause 3 to 6 wherein the food product is comprising the non-hydrogenated vegetable fat composition and the fat composition is comprising:
a. a liquid oil; and
b. a hardstock fat; and
the liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition, and
the fat composition comprises a triglyceride composition comprising, based on total weight of the triglycerides, a content of C54 triglycerides in an amount of from 30 to 50 wt. %, and the fat composition comprises a triglyceride composition comprising, based on total weight of the triglycerides, a combined content of C44 to C48 triglycerides in an amount of from 10 to 25 wt. %.
9. The food product according to any one of clause 7 to 8 wherein the food product is a margarine.
10. The food product according to clause 9 wherein the margarine has a plasticity/hardness of at least 50 g/cm² at 30° C.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Analysis Methods

### Plasticity

Plasticity is measured by measuring hardness of the fat composition between a temperature range of 5 to 30° C. according to in-house method. The hardness is determined with texture analyzer (Type: Stable Micro Systems, Equipment model: TA.XT.PLUS)

### Method

Prepare 10*10*10 cm margarine cubes
Transfer the cubes into thermostatic cabinets separately for 14-16 hours (temperature in a range of 5 to 30° C.)
After tempering, record the margarine cube temperature and the hardness with texture analyzer. (temperature in a range of 5 to 30° C.)

A fat composition having a hardness measurement of less than 1000 g/cm² at 5° C. and greater than 50 g/cm² at 30° C. would be considered to have a good plasticity.

### Heat Stability

Heat stability is measured by tempering the fat composition for 5 hours at 30° C. If there is no oil leakage after the tempering, the fat composition would be considered to have a good heat stability. On the other hand, if there is leakage after tempering, the fat composition would be considered not to have a good heat stability.

### Solid Fat Content (SFC)

Solid fat content is measured according to standard methods AOCS Cd 16b-39 or IUPAC 2.150a.

### Example 1

### Hardstock Preparation

The hardstock fats were prepared by interesterification of a lauric and a non-lauric fat, in presence of 0.05 to 0.2% sodium methoxide, at a temperature of 110° C. for 30 minutes.

The further details are provided in Table 1.

TABLE 1

| | Hardstock A | Hardstock B | Hardstock C |
|---|---|---|---|
| Ingredients | 65 wt. % palm oil | 80 wt. % palm oil | 100% |
| | 35 wt. % lauric fat | 20 wt. % lauric fat | palm oil |

Triglyceride composition (wt. %, expressed on total
weight of the triglycerides)

| | | | |
|---|---|---|---|
| C44 to C48 | 47 | 35 | 10 |

Fatty acid profile (wt. %, expressed on total
weight of the fatty acids)

| | | | |
|---|---|---|---|
| C12 | 16.8 | 9.8 | 0.3 |
| C16 | 41.6 | 34.0 | 39 |
| C12 + C16 | 58.4 | 43.8 | 39.3 |
| C12/C16 | 0.4 | 0.29 | 0.007 |

### Fat Composition

The fat composition was prepared by blending the hardstock with a liquid oil (liquid oil A=soybean oil; liquid oil B=Palm olein).

Ingredient composition, triglyceride composition, and fatty acid profile, of seven formulations of non-hydrogenated vegetable fat composition are shown in Table 2.

TABLE 2

| | | | | | | | |
|---|---|---|---|---|---|---|---|
| Fat Composition | FC-1 | FC-2 | FC-3 | FC-4 | FC-5 | FC-6 | FC-7 |

Ingredients (expressed as a ratio of Hardstock versus Liquid oil)

| | | | | | | | |
|---|---|---|---|---|---|---|---|
| Hardstock A | 41.56 | 28.99 | 33.25 | 24.93 | 16.62 | — | — |
| Hardstock B | — | — | — | — | — | 41.56 | — |
| Hardstock C | — | — | — | — | — | — | 41.56 |
| Liquid oil A | 41.56 | — | 49.87 | 58.19 | 66.50 | 41.56 | 41.56 |
| Liquid oil B | — | 53.83 | — | — | — | — | — |

Ingredients (expressed as wt % of fat composition)

| | | | | | | | |
|---|---|---|---|---|---|---|---|
| Hardstock A | 50 | 35 | 40 | 30 | 20 | — | — |
| Hardstock B | — | — | — | — | — | 50 | — |
| Hardstock C | — | — | — | — | — | — | 50 |
| Liquid oil A | 50 | — | 60 | 70 | 80 | 50 | 50 |
| Liquid oil B | — | 65 | — | — | — | — | — |

Triglyceride composition (wt. %, expressed on total weight of the triglycerides)

| | | | | | | | |
|---|---|---|---|---|---|---|---|
| C44 to C48 | 21.7 | 18.9 | 17.5 | 13 | 10 | 17.9 | 6.4 |
| C54 | 30 | 8 | 37 | 44 | 53 | 35 | 38 |

Fatty acid profile (wt. %, expressed on total weight of the fatty acids)

| | | | | | | | |
|---|---|---|---|---|---|---|---|
| C12 | 8.4 | 6.1 | 6.7 | 5.0 | 3.4 | 4.9 | 0.2 |
| C16 | 26.4 | 40.8 | 23.3 | 20.3 | 17.2 | 22.6 | 25.8 |
| C18 | 4.1 | 4.2 | 4 | 4.0 | 4 | 3.9 | 4.1 |
| C18:1 | 22.5 | 35.5 | 22.4 | 22.4 | 22.3 | 29.5 | 32.2 |
| C18:2 | 29.1 | 8.6 | 34 | 38.9 | 43.8 | 31.4 | 32.2 |
| Sum of Saturated fatty acids | 43 | 55 | 38 | 33 | 28 | 35 | 32 |
| Sum of | 57 | 45 | 62 | 67 | 72 | 65 | 68 |
| Unsaturated fatty acids | | | | | | | |
| Sum of Poly unsaturated fatty | 33 | 8.8 | 36 | 41 | 50 | 35 | — |
| acids | | | | | | | |

Solid Fat Content (SFC)

| | | | | | | | |
|---|---|---|---|---|---|---|---|
| At 10° C. | 37.65 | 52.5 | 29.07 | 21.18 | 14.41 | 24.37 | 24.05 |
| At 40° C. | 0.61 | 0 | 0.41 | 0 | 0 | 0.03 | 0.94 |

### Food Product

The margarines were prepared as follows:
Blending the oils and heating to 70° C., transfer emulsifiers lecithin and monoglycerides to the oil blend.
Dissolve salt in the water phase and adjust the temperature to 60° C.
Transfer the water phase into oil blend and emulsify with agitator for 30 minutes.
Pass the emulsion through the chilling and kneading machine and pack.
Temper the margarine at 15° C. for 2 days, then storage in 5° C.

Ingredient composition, plasticity measurement, and heat stability measurements of seven formulations of non-hydrogenated vegetable fat composition are shown in Table 1.

TABLE 1

| | | | | | | | |
|---|---|---|---|---|---|---|---|
| Formulation | AM-1 | AM-2 | AM-3 | AM-4 | AM-5 | AM-6 | AM-7 |

Ingredients (wt. %, expressed on total weight of the fat composition)

| | | | | | | | |
|---|---|---|---|---|---|---|---|
| Fat composition | FC-1 | FC-2 | FC-3 | FC-4 | FC-5 | FC-6 | FC-7 |

Oil/water content (wt. %, expressed on total weight of the fat composition)

| | | | | | | | |
|---|---|---|---|---|---|---|---|
| Oil content | 83.1 | 82.8 | 83.1 | 83.1 | 83.1 | 83.1 | 83.1 |
| Water content | 15.5 | 15.5 | 15.5 | 15.5 | 15.5 | 15.5 | 15.5 |

Plasticity (g/cm²)

| | | | | | | | |
|---|---|---|---|---|---|---|---|
| Hardness at 5° C. | 715 | 2363 | 451 | 273 | 157 | 594 | 658 |
| Hardness at 30° C. | 100 | 8 | 80 | 55 | 8 | 8 | 40 |
| Slipping Melting Point ° C. | 33.7 | 32.9 | 33.1 | 31 | 28.6 | 30.2 | 34.9 |
| Heat stability | Heat | Not heat | Heat | Heat | Not heat | Not heat | Not heat |
| | stable | stable | stable | stable | stable | stable | stable |

1. A non-hydrogenated vegetable fat composition comprising:
a. a liquid oil; and
b. a hardstock fat;
wherein the liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition.

2. The non-hydrogenated vegetable fat composition according to claim 1,
wherein the fat composition comprises a triglyceride composition comprising, based on total weight of the triglycerides, a content of C54 triglycerides in an amount of from 30 to 50 wt. %.

3. The non-hydrogenated vegetable fat composition according to claim 1, wherein the fat composition comprises a triglyceride composition comprising, based on total weight of the triglycerides, a combined content of C44 to C48 triglycerides in an amount of from 10 to 25 wt. %.

4. The non-hydrogenated vegetable fat composition according to claim 1, wherein the hardstock fat is an interesterified fat obtained by subjecting to an interesterification a blend of an amount of 25 to 45 wt. %, or 35 to 40 wt. %, of at least one lauric fat, and an amount of 55 to 75 wt. %, or 60 to 65 wt. %, of at least one non-lauric fat based on the weight of the hardstock fat.

5. The non-hydrogenated vegetable fat composition according to claim 1, wherein the non-lauric fat is selected from the group consisting of palm oil, soybean oil, rapeseed oil, maize oil, sunflower oil, flaxseed oil, and a blend of two or more thereof.

6. The non-hydrogenated vegetable fat composition according to claim 1, wherein the lauric fat is selected from the group consisting of palm kernel oil, palm kernel stearin, palm kernel olein, coconut oil, coconut stearin, coconut olein, and a blend of two or more thereof.

7. The non-hydrogenated vegetable fat composition according to claim 1, wherein the fat composition has a solid fat content (SFC) which is at least 38 wt. % at 10° C. and less than 3 wt. % at 40° C.

8. The non-hydrogenated vegetable fat composition according to claim 1, wherein the fat composition has a fatty acid profile comprising, based on total weight of the fatty acids, a combined content of C12 and C16 fatty acids in an amount of from 25 to 34 wt. %.

9. The non-hydrogenated vegetable fat composition according to claim 1, wherein the fat composition has a fatty acid profile comprising, based on total weight of the fatty acids, a content of C18:0 fatty acids in an amount of from 4.2 to 4.4 wt. %, a content of C18:1 fatty acids in an amount of from 24.2 to 25.9 wt. %, a content of C18:2 fatty acids in an amount of from 29.6 to 36.9 wt. %, and a content of C18:3 fatty acids in an amount of from 3.5 to 4.1 wt. %.

10. A method for preparing a non-hydrogenated vegetable fat composition according to claim 1, comprising the step of:
a. blending a liquid oil and a hardstock fat;
wherein the liquid oil is present in an amount of 25 to 75 wt. %, 25 to 70 wt. %, or 35 to 45 wt. %, and the hardstock fat is present in an amount of 25 to 75 wt. %, 30 to 75 wt. %, or 55 to 65 wt. %, based upon total weight of the fat composition.

11. A food product comprising a food ingredient different from a fat, and the non-hydrogenated vegetable fat composition according to claim 1.

12. The food product according to claim 11, wherein the food product is selected from the group consisting of margarine, shortening, non-dairy topping, non-dairy cream, filling, and spread.

13. The food product according to claim 11, wherein the margarine has a slipping melting point (SMP) of less than or equal to 36° C.

14. The food product according to claim 11, wherein the margarine has a plasticity of at least 50 g/cm².

15. Use of the non-hydrogenated vegetable fat composition according to claim 1 to reduce oil leakage from a food product selected
